(19) United States
(12) Patent Application Publication
(10) Pub. No.: US 2008/0291677 A1
(43) Pub. Date: Nov. 27, 2008

(54) LED LAMP WITH A PERFORATED COVER PLATE

(76) Inventor: Chuen-Shing CHEN, Taichung Hsien (TW)

Correspondence Address: LADAS & PARRY, 5670 WILSHIRE BOULEVARD, SUITE 2100, LOS ANGELES, CA, 90036-5679, US

(21) Appl. No.: 11/842,805

(22) Filed: Aug. 21, 2007

(30) Foreign Application Priority Data
May 21, 2007 (TW) 096208214

(51) Int. Cl. F21V 21/00; F21V 29/00

(52) U.S. Cl. 362/249; 362/362; 362/373

(57) ABSTRACT

A LED lamp includes a housing, a circuit unit, and a cover plate. The housing includes a housing body surrounding an axis and having an opening. The circuit unit is disposed in the housing body, and includes a base plate that has a first plate surface facing the opening in the housing body, and a light emitting unit that is mounted to the first plate surface of the base plate. The cover plate is disposed in the housing body between the base plate of the circuit unit and the opening in the housing body, and is formed with a through hole unit corresponding in position to the light emitting unit of the circuit unit.

### CROSS-REFERENCE TO RELATED APPLICATION

This application claims priority of Taiwanese Application No. 096208214, filed on May 21, 2007.

### BACKGROUND OF THE INVENTION

1. Field of the Invention

The invention relates to a light emitting diode (LED) lamp, more particularly to a LED lamp with a perforated cover plate.

2. Description of the Related Art

Taiwanese Patent No. M309651 discloses a conventional LED lamp 1 (see FIG. 1) including a base plate 11, a plurality of High-Power LEDs 12 that are soldered to the base plate 11, a plurality of conductive wires 13 that are electrically connected to the LEDs 12, and a plurality of light condensing components 121 that are secured to the base plate 11 using thermal conductive adhesive 14, and that cover up respectively the LEDs 12. However, when the conventional LED lamp 1 is seen from a position in front of an opening 15, the conductive wires 13 and the thermal conductive adhesive 14 are visible, thereby resulting in a relatively low quality appearance.

### SUMMARY OF THE INVENTION

Therefore, the object of the present invention is to provide a LED lamp with a better quality appearance.

Accordingly, a LED lamp of the present invention comprises a housing, a circuit unit, and a cover plate. The housing includes a housing body surrounding an axis and having an opening. The circuit unit is disposed in the housing body, and includes a base plate that has a first plate surface facing the opening in the housing body, and a light emitting unit that is mounted to the first plate surface of the base plate. The cover plate is disposed in the housing body between the base plate of the circuit unit and the opening in the housing body, and is formed with a through hole unit corresponding in position to the light emitting unit of the circuit unit.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional LED lamp;

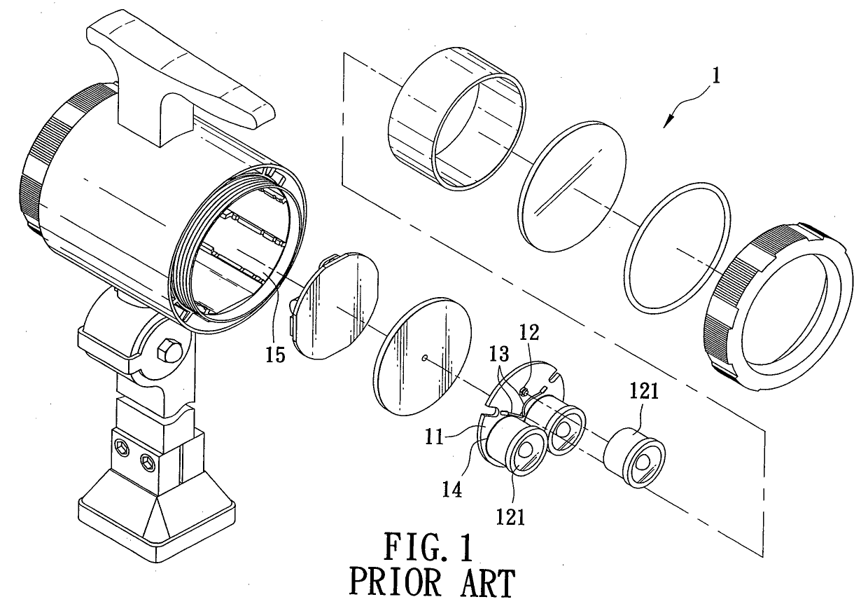

FIG. 2 is an exploded perspective view of a preferred embodiment of a LED lamp according to the invention;

FIG. 3 is a front view of the preferred embodiment; and

FIG. 4 is a fragmentary sectional view of the preferred embodiment.

### DETAILED DESCRIPTION OF THE PREFERRED EMBODIMENT

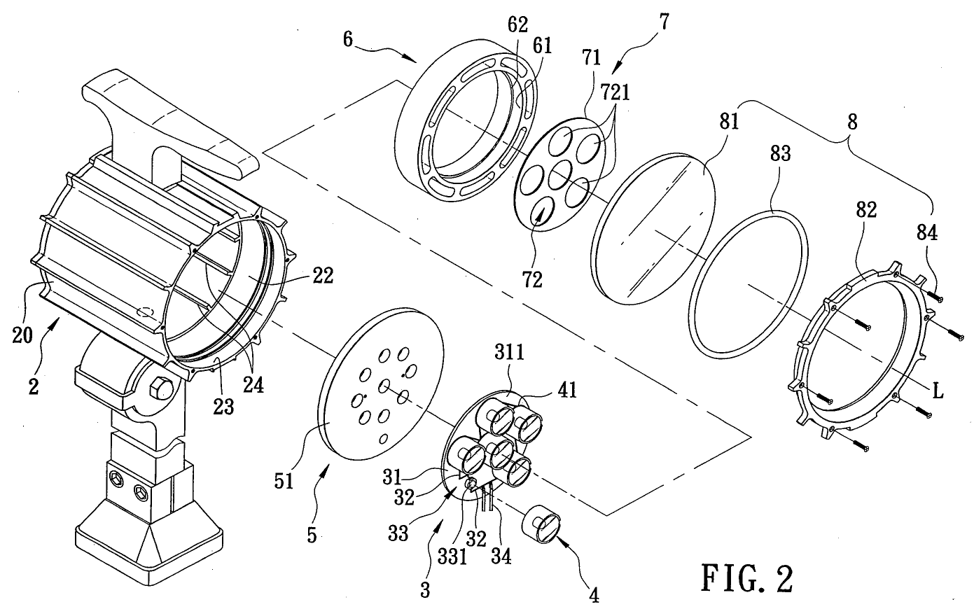

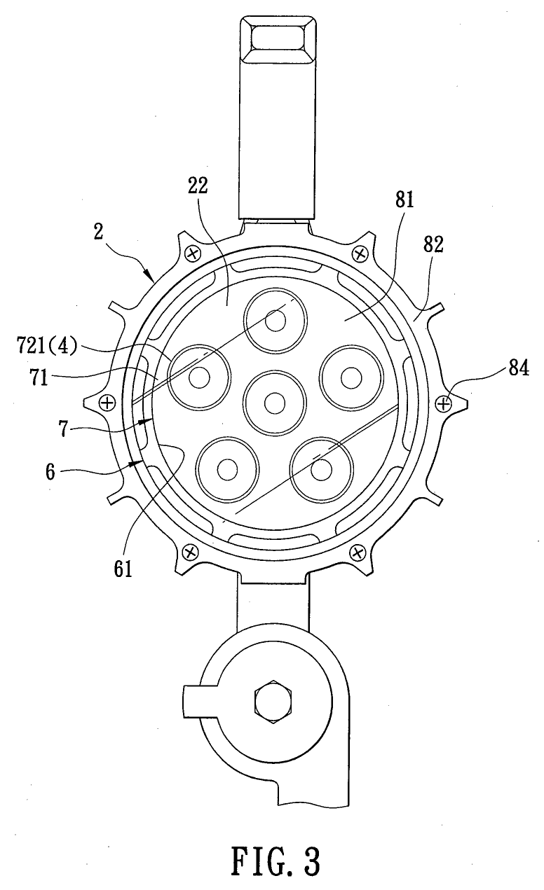

As shown in FIGS. 2 to 4, the preferred embodiment of a LED lamp according to the present invention comprises a housing 2, a circuit unit 3, a plurality of light condensing components 4, a heat dissipating plate 5, a cover plate 7, and a waterproofing transparent cover 8.

The housing 2 includes a housing body 20 that surrounds an axis (L), and that has an opening 22, an inner wall surface 23 surrounding the axis (L), and a plurality of ribs 24 protruding radially and inwardly from the inner wall surface 23. In this embodiment, the housing body 20 is made of aluminum.

The circuit unit 3 is disposed in the housing body 20 of the housing 2, and includes a base plate 31 that has a first plate surface 311 facing the opening 22 in the housing body 20, and a second plate surface 312 disposed opposite to the first plate surface 311. The circuit unit 3 further includes a printed circuit 32 disposed on the first plate surface 311 of the base plate 31, a light emitting unit 33 mounted to the printed circuit 32 and including a plurality of LEDs 331 that face the opening 22, and a conductive wire unit 34 connected electrically to the printed circuit 32.

Each of the light condensing components 4 is mounted on the first plate surface 311 of the base plate 31 of the circuit unit 3 using thermal conductive adhesive 41, and covers up a respective one of the LEDs 331 of the light emitting unit 33 of the circuit unit 3.

The heat dissipating plate 5 is disposed in the housing body 20 of the housing 2, and has one side abutting against the ribs 24 of the housing body 20 of the housing 2, an opposite side coupled to the second plate surface 312 of the base plate 31 of the circuit unit 3, and a peripheral portion 51.

The heat dissipating collar 6 is disposed in the housing body 20 of the housing 2 between the heat dissipating plate 5 and the opening 22 in the housing body 20, surrounds the axis (L), and has an inner annular surface 61 that surrounds the light condensing components 4 and that has a stepped supporting portion 62, and one end that abuts against the peripheral portion 51 of the heat dissipating plate 5.

The cover plate 7 is disposed in the housing body 20 of the housing 2 between the base plate 31 of the circuit unit 3 and the opening 22 in the housing body 20, and is disposed to abut against the supporting portion 62 of the inner annular surface 61 of the heat dissipating collar 6. The cover plate 7 has a plate periphery 71 that contacts the inner annular surface 61 of the heat dissipating collar 6 and that is secured to the heat dissipating collar 6 using the heat conductive adhesive 41, and is formed with a through hole unit 72 that corresponds in position to the light emitting unit 33 of the circuit unit 3, and that includes a plurality of through holes 721 registered with the LEDs 331 of the light emitting unit 33, respectively. Each of the light condensing components 4 corresponds in position to and extends into a respective one of the through holes 721 in the cover plate 7. The cover plate 7 is a metal plate with high thermal conductivity, such as aluminum in this embodiment.

The waterproofing transparent cover 8 is disposed for closing the opening 22 in the housing body 20 of the housing 2. The waterproofing transparent cover 8 includes a transparent plate 81 closing the opening 22 in the housing body 20, a cover body 82 for positioning the transparent plate 81, a seal ring 83 clamped between the transparent plate 81 and the cover body 82, and a plurality of screws 84 for fastening the cover body 82 to the housing body 20. Light emitted from the LEDs 331 of the light emitting unit 33 of the circuit unit 3 passes outwardly of the housing 2 via the light condensing components 4 and the transparent plate 81.

Since the cover plate 7 is disposed between the base plate 31 of the circuit unit 3 and the opening 22 in the housing body 20 of the housing 2, when the LED lamp according to the invention is seen from a position in front of the opening 22 in the housing body 20, the printed circuit 32, the conductive wire unit 34 of the circuit unit 3 and the thermal conductive adhesive 41 on the base plate 31 will be concealed by the cover plate 7, i.e., only the light condensing components 4 can be seen, thereby resulting in a better quality appearance for the LED lamp according to the invention.

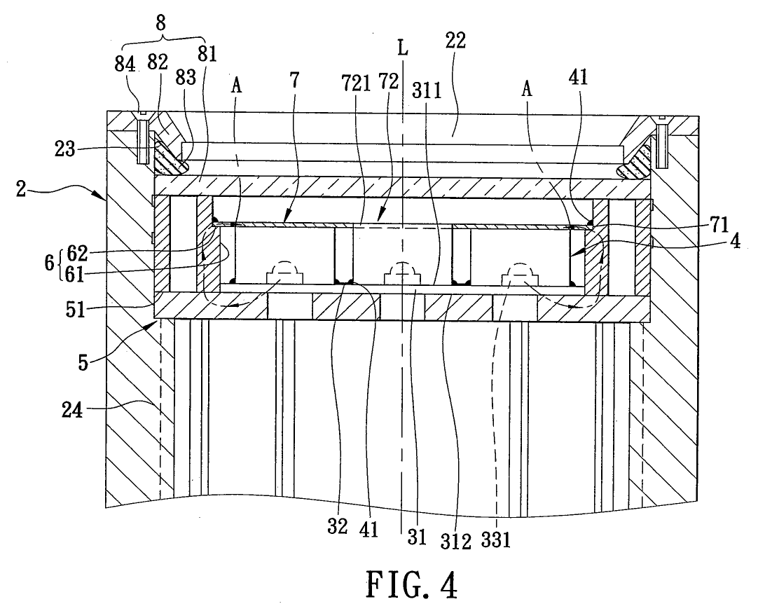

Moreover, when the light emitting diodes 331 of the light emitting unit 33 of the circuit unit 3 emit light, heat will be generated. A part of the heat will be transmitted to the heat dissipating plate 5 via the base plate 31 of the circuit unit 3, will then be transmitted to the heat dissipating collar 6 via the peripheral portion 51 of the heat dissipating plate 5, and will eventually be transmitted to the cover plate 7 via the supporting portion 62 of the heat dissipating collar 6 and the plate periphery 71 of the cover plate 7 along a heat conducting path (A) (as indicated by arrows A in FIG. 4). Therefore, the cover plate 7 also has a heat dissipating capability.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A light emitting diode (LED) lamp comprising:
a housing including a housing body that surrounds an axis, and that has an opening;
a circuit unit disposed in said housing body and including
a base plate that has a first plate surface facing said opening in said housing body, and a second plate surface disposed opposite to said first plate surface, and
a light emitting unit that is mounted to said first plate surface of said base plate; and
a cover plate disposed in said housing body between said base plate of said circuit unit and said opening in said housing body, and formed with a through hole unit that corresponds in position to said light emitting unit of said circuit unit.

2. The LED lamp as claimed in claim 1, wherein said light emitting unit includes a plurality of light emitting diodes, and said through hole unit includes a plurality of through holes registered with said light emitting diodes, respectively.

3. The LED lamp as claimed in claim 2, further comprising a plurality of light condensing components, each of which is disposed on said first plate surface of said base plate of said circuit unit, covers up a respective one of said light emitting diodes of said light emitting unit of said circuit unit, and corresponds in position to a respective one of said through holes in said cover plate.

4. The LED lamp as claimed in claim 3, wherein each of said light condensing components extends into the respective one of said through holes.

5. The LED lamp as claimed in claim 3, further comprising:
a heat dissipating plate that is disposed in said housing body of said housing, that is coupled to said second plate surface of said base plate of said circuit unit, and that has a peripheral portion; and
a heat dissipating collar that is disposed in said housing body, and that has
an inner annular surface surrounding said light condensing components and having a stepped supporting portion, and
one end abutting against said peripheral portion of said heat dissipating plate;
said cover plate being disposed to abut against said supporting portion of said inner annular surface of said heat dissipating collar, and having a plate periphery that contacts said inner annular surface.

6. The LED lamp as claimed in claim 1, wherein said cover plate is a metal plate.
